(19) United States
(12) Patent Application Publication
(10) Pub. No.: US 2014/0347598 A1
(43) Pub. Date: Nov. 27, 2014

(54) BACKLIGHT MODULE AND LIQUID CRYSTAL DISPLAY

(71) Applicants: Shih-hsiang Chen, Shenzhen (CN); Gege Zhou, Shenzhen (CN)

(72) Inventors: Shih-hsiang Chen, Shenzhen (CN); Gege Zhou, Shenzhen (CN)

(73) Assignee: Shenzhen China Star Optoelectronics Technology Co., Ltd., Shenzhen (CN)

(21) Appl. No.: 13/502,135

(22) PCT Filed: Mar. 5, 2012
(86) PCT No.: PCT/CN2012/071906

§ 371 Date: Apr. 15, 2012

(30) Foreign Application Priority Data
Feb. 13, 2012 (CN) 201210031533.7

(51) Int. Cl. G02F 1/1335; F21V 21/00

(52) U.S. Cl. CPC G02F 1/1336; F21V 21/00
USPC 349/61; 362/97.1

(57) ABSTRACT

A backlight module and a liquid crystal display are disclosed, and the backlight module comprises a backboard where the backboard comprises a backboard main body and side walls. The side wall is provided with a light emitting article at its inner side, and the light emitting article and the backboard main body are provided with a support fixation article in between, for the support and immobilization of the light emitting article. This invention assures the alignment of the light emitting article with a light guide plate, which substantially boosts the incident efficiency of the light emitting article.

### BACKGROUND OF THE INVENTION

1. Field of the Invention

The present invention relates to liquid crystal display domain. More particularly, the present invention relates to a backlight module and a liquid crystal display.

2. Description of the Prior Art

With the advancement and popularity of liquid crystal display panels, the demand for the parts of the liquid crystal display panel is getting higher.

To exemplify a backlight module, referring to FIG. 1, FIG. 1 is a schematic diagram of the structure of the backlight module of a lateral incident light type of light emitting diode (LED) in prior art techniques. The backlight module of the lateral incident light type of LED comprises a front frame 11, a rubber frame 12, a light ribbon 13, a backboard 14, a light guide plate 15 and heat conductive glue 16.

Wherein, the light ribbon 13 is fixed to the backboard 14 by means of the heat conductive glue 16. In the process of adhesion of the light ribbon 13 to the backboard 14, it is substantially difficult to assure that the light ribbon 13 can be accurately adhered to the right position. Once the location of the light ribbon 13 deviates, the alignment of the light ribbon 13 with the light guide plate 15 is affected, which further brings about inferiority of the incident efficiency of the incident light of the light ribbon 13 into the light guide plate 15.

On the other hand, the light ribbon 13 will give off mass heat during the operation that softens the heat conductive glue 16, causing the light ribbon 13 to shift down that comes to a misalignment, and affecting the alignment of the light ribbon 13 with the light guide plate 15, which brings about inferiority of the incident efficiency of the light ribbon 13 into the light guide plate 15.

In summary, since the light ribbon 13 is fixed to the backboard 14 by means of the heat conductive glue 16, the adhesive position is laborious to control; and the heat irradiated by the light ribbon 13 during the operation softens the heat conductive glue 16, causing the light ribbon 13 to shift down that comes to a misalignment. The aforesaid two circumstances affect the alignment of the light ribbon 13 with the light guide plate 15, which further brings about inferiority of the incident efficiency of the light ribbon 13.

### SUMMARY OF THE INVENTION

The objective of the present invention is to provide a backlight module, to settle a conventional technique of laborious in accurate control of the light ribbon that is fixed to the backboard by heat conductive glue; and the heat irradiated by the light ribbon during the operation softens the heat conductive glue, causing the light ribbon to shift down that comes to a misalignment, affecting the alignment of the light ribbon with the light guide plate that brings about a technical issue of the inferiority of the incident efficiency of the light ribbon.

To settle the aforementioned issue, the present invention provides a backlight module, comprising a backboard where the backboard comprises a backboard main body, and side walls formed by bending two ends of the backboard main body and formed into one-piece with the backboard main body. The side wall comprises a side wall body. The side wall is provided with a light emitting article at its inner side;

the light emitting article comprises a light ribbon, the light ribbon is provided with a plurality of light sources evenly arranged; and

the light emitting article and the backboard main body are provided with a support fixation article in between where the support fixation article is formed by bending a portion of the side wall body with respect to the side wall body, for the support and immobilization of the light emitting article.

In the backlight module of this invention, the backlight module further comprises a L-type stand where the L-type stand comprises a first stand bar stuck to the outer side of the side wall, and a second stand bar stuck to the outer side of the backboard main body, and a portion of the first stand bar bends toward the inner side of the side wall, and extends over the side wall to form the support fixation article.

In the backlight module of this invention, the second stand bar is provided with a reinforced length and joins fixedly to the backboard main body.

The other objective of the present invention is to provide a backlight module, to settle a technical issue of laborious in accurate control of the light ribbon that is fixed to the backboard by heat conductive glue; and the, heat irradiated by the light ribbon during the operation softens the heat conductive glue, causing the light ribbon to shift down that comes to a misalignment, affecting the alignment of the light ribbon with the light guide plate that brings about a technical issue of inferiority of the incident efficiency of the light ribbon.

To settle the aforementioned issue, the present invention provides a backlight module, comprising a backboard where the backboard comprises a backboard main body, and side walls formed by bending of two ends of the backboard main body and formed into one-piece with the backboard main body. The side wall is provided with a light emitting article at its inner side;

the light emitting article and the backboard main body are provided with a support fixation article in between, for the support and immobilization of the light emitting article.

In the backlight module of this invention, the side wall comprises a side wall body, and the support fixation article is formed by bending a portion of the side wall body with respect to the side wall body.

In the backlight module of this invention, the backlight module further comprises a L-type stand where the L-type stand comprises a first stand bar stuck to the outer side of the side wall, and a second stand bar stuck to the outer side of the backboard main body, and a portion of the first stand bar bends toward the inner side of the side wall, and extends over the side wall to form the support fixation article.

In the backlight module of this invention, the second stand bar is provided with a reinforced length and joins fixedly to the backboard main body.

In the backlight module of this invention, the light emitting article comprises a light ribbon, the light ribbon is provided with a plurality of light sources evenly arranged.

Another objective of the present invention is to provide a backlight module, to settle a technical issue of laborious in accurate control of the light ribbon that is fixed to the backboard by heat conductive glue; and the heat irradiated by the light ribbon during the operation softens the heat conductive glue, causing the light ribbon to shift down that comes to a misalignment, affecting the alignment of the light ribbon with the light guide plate that brings about a technical issue of inferiority of the incident efficiency of the light ribbon.

To settle the aforementioned issue, the present invention constructs a liquid crystal display, the liquid crystal display comprises a backlight module, and the backlight module comprises a backboard where the backboard comprises a backboard main body, and side walls formed by bending of two ends of the backboard main body and formed into one-piece with the main body. The side wall is provided with a light emitting article at its inner side;

the light emitting article and the backboard main body are provided with a support fixation article in between, for the support and immobilization of the light emitting article.

In the liquid crystal display of this invention, the side wall comprises a side wall body, and the support fixation article is formed by bending a portion of the side wall body with respect to the side wall body.

In the liquid crystal display of this invention, the backlight module further comprises a L-type stand where the L-type stand comprises a first stand bar stuck to the outer side of the side wall, and a second stand bar stuck to the outer side of the backboard main body, and a portion of the first stand bar bends toward the inner side of the side wall, and extends over the side wall to form the support fixation article.

In the liquid crystal display of this invention, the second stand bar is provided with a reinforced length and joins fixedly to the backboard main body.

In the liquid crystal display of this invention, the light emitting article comprises a light ribbon, the light ribbon is provided with a plurality of light sources evenly arranged.

Relative to the conventional techniques, this invention is provided with a support fixation article disposed in between the light emitting article and the backboard main body where the support fixation article supports and immobilizes the light emitting article, enabling accurately to fix the light emitting article to the side wall of the backboard, and even the heat irradiated by the light ribbon during the operation softens the heat conductive glue, capable of guaranteeing the position of the light emitting article free of misalignment and guaranteeing the alignment of the light ribbon with the light guide plate, which boosts the incident efficiency of the light ribbon.

This invention is detailed described with reference to the following preferred embodiments and the accompanying drawings for better comprehension.

### BRIEF DESCRIPTION OF THE DRAWINGS

FIG. 1 is a schematic diagram of the structure of a backlight module of prior art techniques;

FIG. 2 is a schematic diagram of the structure of the backlight module of the first preferred embodiment of the present invention;

FIG. 3 is a schematic diagram of the joint between a backboard of the backlight module and a support fixation article of FIG. 2;

FIG. 4 is a schematic diagram of the structure of the backlight module of the second preferred embodiment of the present invention; and

FIG. 5 is a schematic diagram of the joint among a backboard of the backlight module, a support fixation article and an L-type stand of FIG. 4.

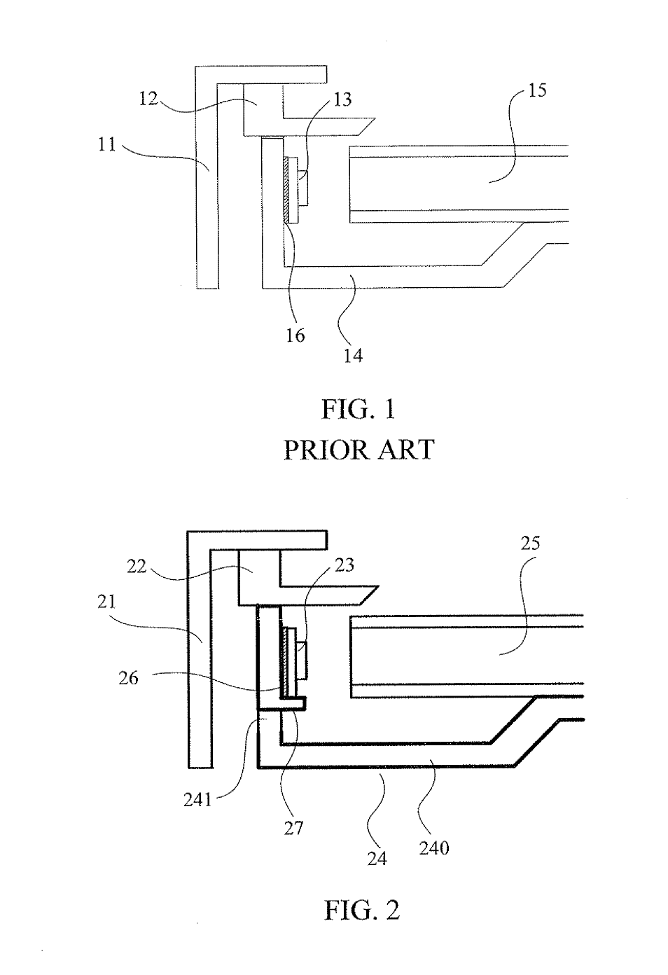

### DETAILED DESCRIPTION OF THE INVENTION

The following embodiments are described with reference to the following accompanying drawings which exemplify the realizations of this invention.

Referring to FIG. 2, FIG. 2 is a schematic diagram of the structure of the backlight module of the first preferred embodiment of the present invention.

The backlight module comprises a front frame 21, a rubber frame 22, a light emitting article 23, a backboard 24, a light guide plate 25, heat conductive glue 26 and a support fixation article 27.

Wherein, the front frame 21 connects to the rubber frame 22, and the rubber frame 22 carries a display (not shown in the figures). The backboard 24 comprises a backboard main body 240 and side walls 241 where the side walls 241 are formed by bending the two ends of the backboard main body 240, and the side walls 241 and the backboard main body 240 are formed into one-piece. The light emitting article 23 is disposed at the inner side of the side walls 241. The support fixation article 27 is disposed in between the light emitting article 23 and the backboard main body 240. The support fixation article 27 is used for the support and immobilization of the light emitting article 23.

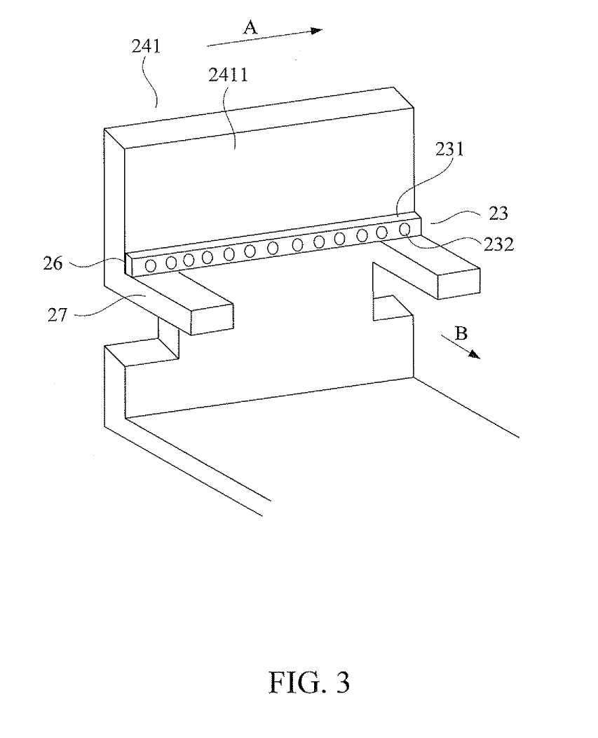

Referring to FIG. 3, FIG. 3 is a schematic diagram of the joint between a backboard of the backlight module and a support fixation article of FIG. 2.

The side wall 241 comprises a side wall body 2411. The support fixation article 27 is located at two ends of the side wall body 2411 along the direction of A and formed by bending a portion of the side wall body with respect to the side wall body.

Undoubtedly, in the process of realization, the support fixation article 27 further can be formed in the middle of the side wall body 2411 along the direction of A. It works as long as the light emitting article 23 can be supported. And there is no enumeration in detail hereto.

Referring again to FIG. 3, the light emitting article 23 comprises a light ribbon 231; the light ribbon 231 extends along the direction A and is provided with plural light sources 232 evenly arranged.

FIG. 2 shows the working principle of the first embodiment of the backlight module:

Referring to FIGS. 2 and 3, the light emitting article 23 is fixed to the side walls 241 of the backboard 24 by heat conductive glue 26, and at the same time the light emitting article 23 is fixed to the support fixation article 27 and aligned with the light guide plate 25. As such, the support fixation article 27 can support and immobilize the light emitting article 23, such that the light emitting article 23 and the light guide plate 25 have better outcome in the alignment one with the other.

Once the light emitting article 23 gives off light, even the heat irradiated by light emitting article 23 softens the heat conductive glue 26, due to support and immobilization by the support fixation article 27, the light emitting article 23 wouldn't suffer a misalignment, assuring the alignment of the light emitting article 23 with the light guide plate 25 that further boosts the light incident efficiency of the light emitting article 23.

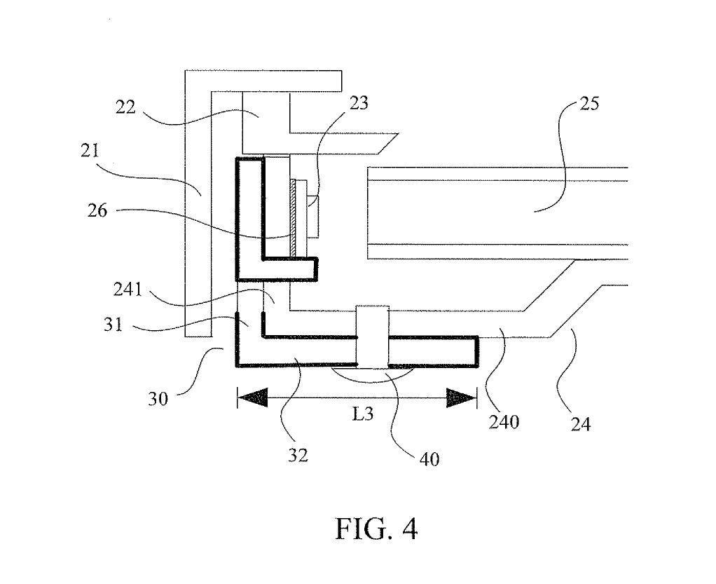

FIG. 4 is a schematic diagram of the structure of the backlight module of the second preferred embodiment of the present invention.

In the second preferred embodiment shown in FIG. 4, the backlight module further comprises an L-type stand 30 where the L-type stand 30 comprises a first stand bar 31 and a second stand bar stuck 32. The first stand bar 31 is stuck to the outer side of the side wall 241, and the second stand bar 32 is stuck to the outer side of the backboard main body.

Referring to FIG. 4 continuously, the backlight module further comprises a screw nut 40, and the second stand bar 32 and the backboard main body 240 are provided with a screw hole (not shown in the figures) where the screw nut 40 penetrates the screw holes of the second stand bar 32 and the backboard main body 240 and in spiral fixing, enabling the second stand bar 32 and the backboard main body 240 to have a riveted joint. It surely can be other ways of fixed joint. And there is no enumeration in detail hereto.

The second stand bar 32 is provided with a reinforced length L3 where the second stand bar 32 having the reinforced length L3 can reinforce the backboard 24 to guarantee smoothness of the backlight module.

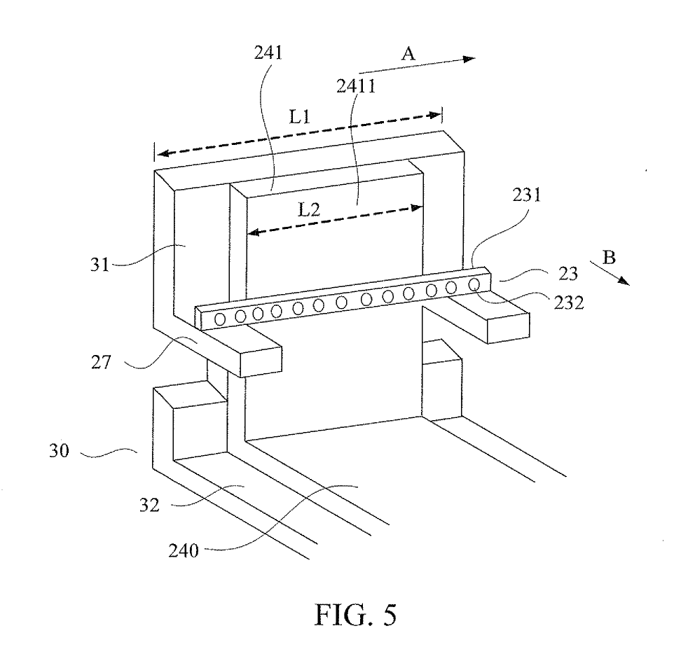

Referring to FIG. 5, FIG. 5 is a schematic diagram of the joint among a backboard 24 of the backlight module, a support fixation article 27 and an L-type stand 30 of FIG. 4.

The length of the first stand bar 31 is parallel to the direction A. And the length L1 of the first stand bar 31 is larger than the length L2 of the side wall 241. At the two ends of the first stand bar 31 along the direction A, portions of the first stand bar 31 bend toward inner side of the side wall 241, and the bent portions extend along the direction B and over the side wall 241 to form the support fixation article 27.

In the embodiment shown in FIG. 5, the support fixation article 27 forms at both ends of the first stand bar 31 along the direction A. During the process of the realization, the support fixation article 27 further can be formed in the middle of the first stand bar 31 along the direction of A. At this point, once the support fixation article 27 is demanded to penetrate the side wall 241, it should have a through hole at the side wall 241. As long as the support fixation article 27 penetrates the side wall 241, and supports the light emitting article 23, which are all construed to be within the scope of this invention. And there is no enumeration in detail hereto.

FIG. 4 shows the working principle of the second preferred embodiment of the backlight module.

Referring together to FIGS. 4 and 5, once the light emitting article 23 is adhered to the side wall 241 of the backboard 24 by heat conductive glue, at the same time the light emitting article 23 is fixed on the support fixation article 27, and the light emitting article 23 is aligned with the light guide plate 25. As such, the support fixation article 27 can support and immobilize the light emitting article 23, such that the light emitting article 23 and the light guide plate 25 have better outcome in the alignment one with the other.

Once the light emitting article 23 gives off light, even the heat irradiated by light emitting article 23 softens the heat conductive glue 26, due to support and immobilization by the support fixation article 27, the light emitting article 23 wouldn't suffer a misalignment, assuring the alignment of the light emitting article 23 with the light guide plate 25 that further boosts the light incident efficiency of the light emitting article 23.

Moreover, the second stand bar 32 is provided with a reinforced length L3 where the second stand bar 32 having the reinforced length L3 can reinforce the backboard 24, to guarantee smoothness of the backlight module.

This invention is provided with a support fixation article 27 disposed in between the light emitting article 23 and the backboard main body 240 where the support fixation article 27 supports and immobilizes the light emitting article 23, enabling accurately to fix the light emitting article 23 to the side wall of the backboard, and even the heat irradiated by the light emitting article 23 during the operation softens the heat conductive glue 26, capable of guaranteeing the position of the light emitting article 23 free of misalignment and guaranteeing the alignment of the light emitting article 23 with the light guide plate 25, which boosts the incident efficiency of the light emitting article 23.

In general, although a few preferred embodiments of the present invention have been disclosed, the above preferred embodiments are not used for limiting this invention, and it will be understood by those of ordinary skill in the art that various changes in form and details may be made therein without departing from the spirit and scope of the present invention.

What is claimed is:

1. A backlight module, comprising a backboard, wherein the backboard comprises a backboard main body, and side walls, formed by bending two ends of the backboard main body and formed into one-piece with the backboard main body, the side wall comprising a side wall body, and the side wall being provided with a light emitting article at its inner side, wherein:
the light emitting article comprises a light ribbon, and the light ribbon is provided with a plurality of light sources evenly arranged;
the light emitting article and the backboard main body are provided with a support fixation article in between where the support fixation article is formed by bending a portion of the side wall body with respect to the side wall body, for the support and immobilization of the light emitting article.

2. The backlight module as claimed in claim 1, wherein the backlight module further comprises a L-type stand where the L-type stand comprises a first stand bat stuck to the outer side of the side wall, and a second stand bar stuck to the outer side of the backboard main body where a portion of the first stand bar bends toward the inner side of the side wall and extends over the side wall to form the support fixation article.

3. The backlight module as claimed in claim 2, wherein the second stand bar is provided with a reinforced length and joins fixedly to the backboard main body.

4. A backlight module, comprising a backboard, wherein the backboard comprises a backboard main body, and side walls, formed by bending two ends of the backboard main body and formed into one-piece with the backboard main body, and the side wall being provided with a light emitting article at its inner side, wherein:
the light emitting article and the backboard main body are provided with a support fixation article in between, for the support and immobilization of the light emitting article.

5. The backlight module as claimed in claim 4, wherein the side wall comprises a side wall body, and a portion of the side wall body bending with respect to the side wall body to form the support fixation article.

6. The backlight module as claimed in claim 4, wherein the backlight module further comprises a L-type stand where the L-type stand comprises a first stand bar stuck to the outer side of the side wall, and a second stand bar stuck to the outer side of the backboard main body where a portion of the first stand bar bends toward the inner side of the side wall and extends over the side wall to form the support fixation article.

7. The backlight module as claimed in claim 6, wherein the second stand bar is provided with a reinforced length and joins fixedly to the backboard main body.

8. The backlight module as claimed in claim 4, wherein the light emitting article comprises a light ribbon, and the light ribbon being provided with a plurality of light sources evenly arranged.

9. A liquid crystal display, wherein the liquid crystal display comprises a backlight module, and the backlight module comprising a backboard where the backboard comprises a backboard main body, and side walls formed by bending of two ends of the backboard main body and formed into one-piece with the main body, the side wall being provided with a light emitting article at its inner side;
the light emitting article and the backboard main body being provided with a support fixation article in between, for the support and immobilization of the light emitting article.

10. The liquid crystal display as claimed in claim 9, wherein the side wall comprises a side wall body, and a portion of the side wall body bending with respect to the side wall body to form the support fixation article.

11. The liquid crystal display as claimed in claim 9, wherein the backlight module further comprises a L-type stand where the L-type stand comprises a first stand bar stuck to the outer side of the side wall, and a second stand bar stuck to the outer side of the backboard main body where a portion of the first stand bar bends toward the inner side of the side wall and extends over the side wall to form the support fixation article.

12. The liquid crystal display as claimed in claim 11, wherein the second stand bar is provided with a reinforced length and joins fixedly to the backboard main body.

13. The liquid crystal display as claimed in claim 9, wherein the light emitting article comprises a light ribbon and the light ribbon is provided with a plurality of light sources evenly arranged.
